(19) United States
(12) Patent Application Publication
(10) Pub. No.: US 2012/0274818 A1
(43) Pub. Date: Nov. 1, 2012

(54) IMAGE PROCESSING APPARATUS AND IMAGE PROCESSING METHOD

(76) Inventor: Kaoru Matsuoka, Tokyo (JP)

(21) Appl. No.: 13/407,481

(22) Filed: Feb. 28, 2012

(30) Foreign Application Priority Data
Apr. 27, 2011 (JP) 2011-099750

(51) Int. Cl. H04N 9/64

(52) U.S. Cl. 348/246; 348/E05.078

(57) ABSTRACT

According to one embodiment, an image processing apparatus includes, a calculation module configured to find the correspondence between an arbitrary pixel of a first image input as a first image signal and an arbitrary pixel of a second image input as a second image signal acquired at the same time as the first image signal about the same subject, a determination module configured to compare the arbitrary pixel of the first image with the arbitrary pixel of the second image based on the calculation result of the calculation module and to determine whether the individual pixels are noise pixels or non-noise pixels differing from noise pixels, and a noise removal module configured to correct noise pixels based on the determination result of the determination module.

### CROSS-REFERENCE TO RELATED APPLICATIONS

This application is based upon and claims the benefit of priority from prior Japanese Patent Application No. 2011-099750, filed Apr. 27, 2011, the entire contents of which are incorporated herein by reference.

### FIELD

Embodiments described herein relate generally to an image processing apparatus and an image processing method which handle stereo images and multiple images.

### BACKGROUND

Various image processing methods of finding or trying to find the correspondence between pixels in stereo images or multiple images have been proposed.

As for stereo images or multiple images, a method of removing imaging-device-generated noise in image signals cannot be said to have been established sufficiently. Methods of removing noise efficiently and of alleviating a bad effect on image quality are particularly far from having been established sufficiently.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a block diagram of an image processing apparatus according to an embodiment;

FIG. 2 is a flowchart to explain an image processing method according to the embodiment;

FIG. 3 is a flowchart to explain the image processing method according to the embodiment;

FIG. 4 is a flowchart to explain the image processing method according to the embodiment; and

FIG. 5 is a flowchart to explain the image processing method according to the embodiment.

### DETAILED DESCRIPTION

Various embodiments will be described hereinafter with reference to the accompanying drawings. In general, according to one embodiment, an image processing apparatus comprises: a calculation module configured to find the correspondence between an arbitrary pixel of a first image input as a first image signal and an arbitrary pixel of a second image input as a second image signal acquired at the same time as the first image signal about the same subject; a determination module configured to compare the arbitrary pixel of the first image with the arbitrary pixel of the second image based on the calculation result of the calculation module and to determine whether the individual pixels are noise pixels or non-noise pixels differing from noise pixels; and a noise removal module configured to correct noise pixels based on the determination result of the determination module.

Embodiments will now be described hereinafter in detail with reference to the accompanying drawings.

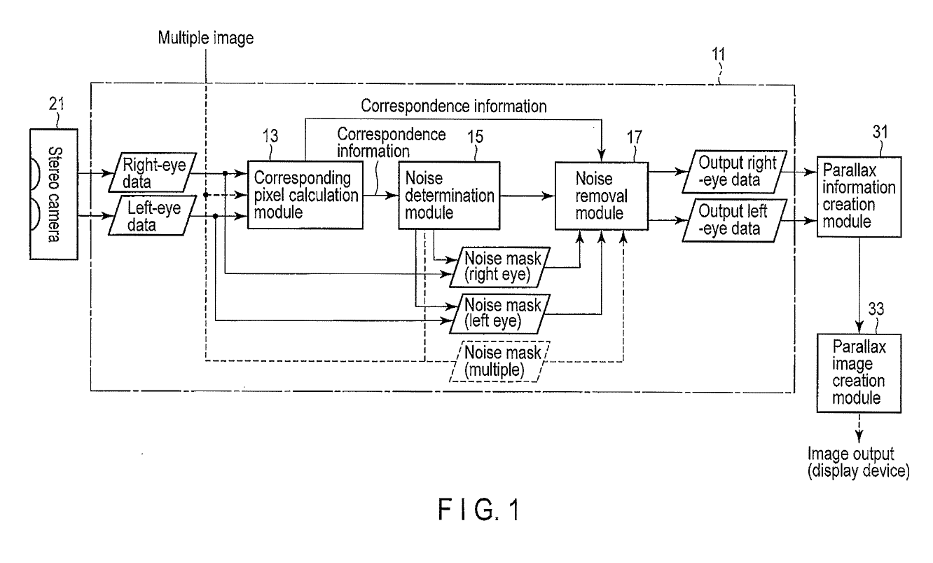

FIG. 1 is a block diagram of an image processing apparatus (e.g., an image signal processing apparatus incorporated in a stereo camera) according to an embodiment. Elements, configurations, or functions explained below may be realized by hardware or by software on a microcomputer (processor, CPU) or the like. Elements/components described to as “module” below may be obtained by hardware or may be obtained by software using, for example, a microcomputer (processor, CPU), etc.

An image processing apparatus 11 shown in FIG. 1 includes a corresponding pixel calculation module 13 that calculates corresponding pixels from pixels of at least two input images, a noise determination module 14 that determines whether there is noise (a noise component) in input images on the basis of the calculation result of the corresponding pixel calculation module 13, and a noise removal module 17 that removes noise determined by the noise determination module 14.

In many cases, the image processing apparatus 11 includes a parallax information creation module 31 and a parallax image creation module 33 in a subsequent stage (in a downstream) of the noise removal module 17. The parallax information creation module 31 and parallax image creation module 33 convert an input image into a right viewpoint output image signal and a left viewpoint output image signal which a display device can display and output the converted signals to image signal output terminals or output interfaces. The image processing apparatus 11 and the display device may be integrally formed to enable stereo images to be displayed (e.g., like a “portable information terminal device” integral with a display device).

The input image includes right-eye data (image output) and left-eye data (image output) produced by a stereo camera 21 which includes at least two cameras or two lenses separated right and left a specific distance apart and a camera.

The input image may be a multiple image obtained by preparing three or more cameras or a single camera with three or more lenses and taking an image with the cameras or the single camera. The input image may be either a still image or a moving image (a non-static image). When the input image is a moving image, the individual still images constituting a moving image have only to have been taken at the same time that enables a comparison to be made at the corresponding pixel calculation module 13. That is, the input image has only to be such that two or more images have been taken from the same subject at the same instant and may not be restricted by an imaging method. As long as the input images are two or more images taken from the same subject, they can be applied even if they differ in size (magnification).

In addition, the input image is not limited to the output from a camera. For instance, it may be an image signal input to an input terminal of a television device (television receiver/image display device) or a recorder (video reproducing device). In this case, noise is removed (as described later), taking into account that noise components produced by a signal process, such as compression, are superimposed on all the images to be compared, which enables the same effect to be expected.

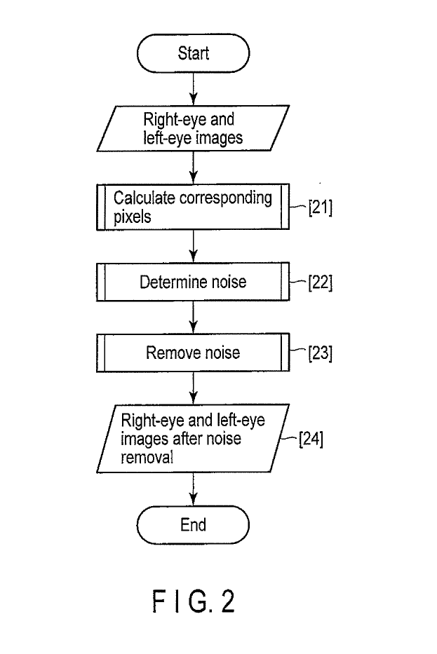

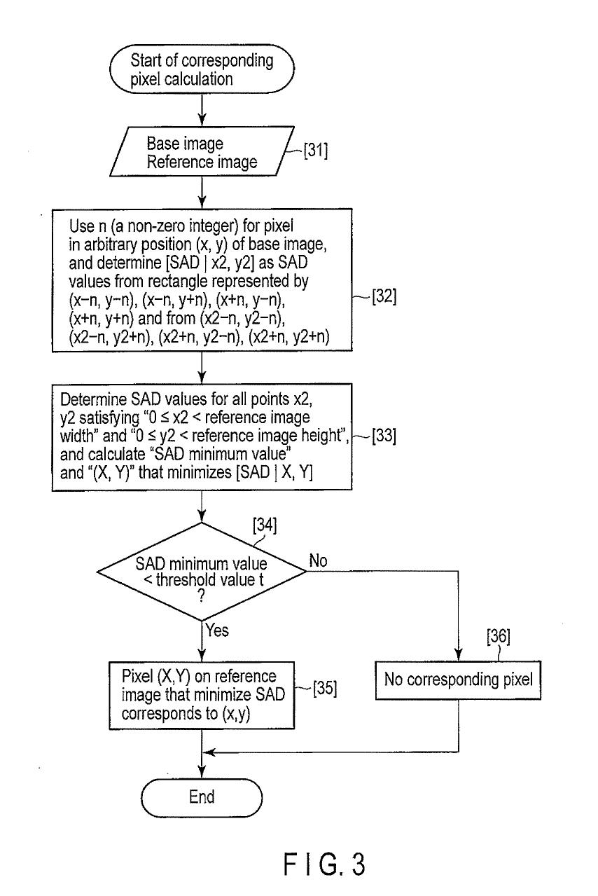

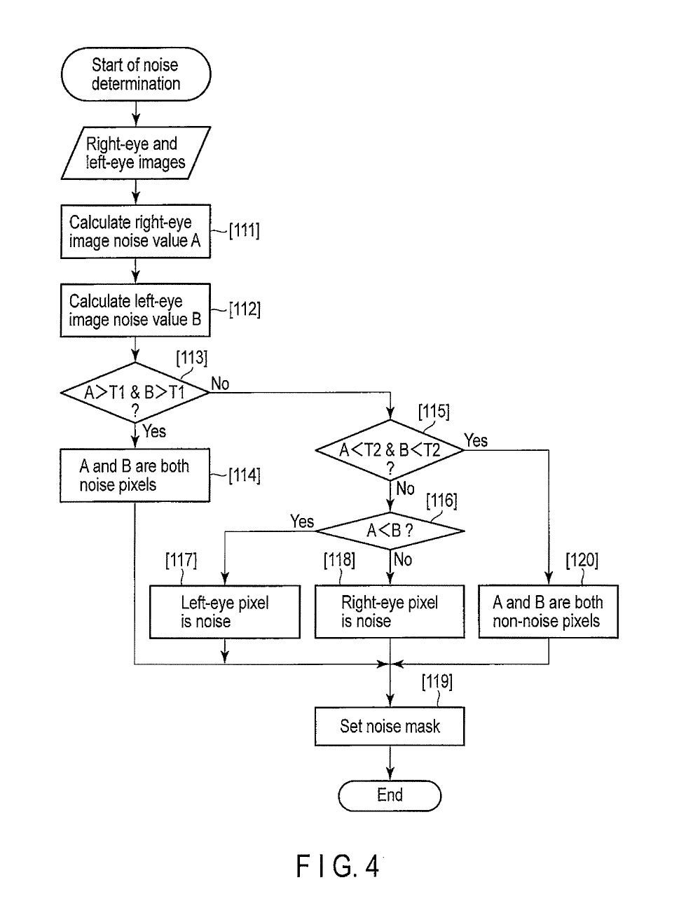

The noise determination module 15 will be explained in detail with reference to FIGS. 3 and 4. In general, according to a flowchart shown in FIG. 2, the corresponding pixel calculation module 13 calculates corresponding pixels [21]. Referring to correspondence information output by the corresponding pixel calculation module 13, it is determined whether some or all of the input images have noise, or whether any image has no noise (or none of the images have noise) [22].

If having determined that some or all of the images (one image when there are two images) have noise, the noise determination module 15 forms a noise mask that shows noise information so as to enable the noise removal module 17 in a subsequent stage to use the information. In this proposition, suppose, for example, a “bright point component” in a black image or a monochromatic image of a specific concentration, a “high-concentration or chromatic color component” in a white image or in a low-concentration area lower than a specific concentration”, a “sporadic component” differing from peripheral components in a creation process (or formation condition), or multiple components of them are treated as noise. Therefore, when a noise mask is formed, even if, for example, hair or the like has adhered to the lens on a camera, it is desirable that the noise determination module 15 should have a “(non-noise) dictionary” which is referred to in order to determine that what has adhered to the lens is not noise or is non-noise.

The noise removal module 17 will be explained in detail with reference to FIGS. 3 to 5. Generally, according to the flowchart of FIG. 2, the noise removal module 17 removes noise in the remaining images with one of the images as a reference by using the noise mask output by the noise determination module 15 or the correspondence information output by the corresponding pixel calculation module 13. For example, when there are two images, an arbitrary pixel (pixel value) of one image is used as a reference and the corresponding pixel (pixel value) of the other image is processed. Specifically, using the pixel value of an image which has been determined to have no noise by the noise determination module 15, the corresponding pixel of an image determined to have noise, i.e., to determine an image is noised, is complemented by information obtained from surrounding pixels [23].

As described above, the individual images (input images) from which noise has been removed by the noise removal module 17 on the basis of the determination result of the noise determination module 15 are output as an output right-eye image and an output left-eye image, while the positional relationship at the time of inputting is being kept. That is, the input image from the right-eye camera (or for the right eye) is output as an output right-eye image to a subsequent stage and the input image from the left-eye camera (or for the left eye) is output as an output left-eye image to a subsequent stage [24].

FIG. 3 shows a detailed example. The corresponding pixel calculation module 13 sets one of the input images as a base image and the other as a reference image [31].

Hereinafter, n (a non-zero integer) is used for a pixel in an arbitrary position (x, y) of a base image and [SAD|x2, y2] is determined as the sum of absolute differences (SAD) from a (4-valued) rectangle represented by (x−n, y−n), (x−n, y+n), (x+n, y−n), (x+n, y+n) and from (x2−n, y2−n), (x2−n, y2+n), (x2+n, y2−n), (x2+n, y2+n) for x2, y2 satisfying “0≦x2<reference image width”, “0≦y2<reference image height”[32]. Then, “SAD minimum value” and “(X, Y)” that minimizes [SAD|X, Y] are calculated, i.e., “calculating a reference image and an SAD for window with a center pixel of each of pixel of the base image (SAD calculations for a window centering on each pixel of the standard image with reference to the reference image)” are executed [33].

If the calculate “SAD minimum value” is less than threshold value [34-YES], “(X, Y)” is determined to be the corresponding pixel on the reference image for the base image (x, y), i.e., “determining a corresponding pixel for the reference is the minimum SAD image (SAD minimum pixel is corresponding pixel on reference image) [35]. If the “SAD minimum value” is greater than or equal to threshold value t [34-NO], it is determined that there is no corresponding pixel [36].

The above corresponding point calculation is done for all the pixels (x, y) on the reference image that satisfy the expressions “0≦x<base image width”, “0≦y<base image height”.

Next, FIG. 4 shows an example. In FIG. 4, it is determined which of pixel (x, y) obtained by the corresponding pixel calculation (FIG. 3) done by the noise determination module 15 and “(X, Y)” corresponding to pixel (x, y) has noise (in noise determination) [111] to [120]. In the explanation below, suppose a right-eye image is a base image and a left-eye image is a reference image.

Specifically, the left-eye image (reference image), the right-eye image (base image), and pixel correspondence information found from FIG. 3 are input, determining a noise value for each of the pixels of each input image. Then, a noise mask representing one of [single (noise)], [non (noise)], [both (noise)], and [both non (noise)] is output.

Let a noise value be the sum of absolute difference between (x, y) and each of surrounding pixels (x−1, y), (x+1, y), (x, y−1), and (x, y+1).

Of noise value A (base image) of pixel (x, y) and noise value B (reference image) of (X, Y), the greater one of the noise values is determined to be a single noise pixel ([single (noise)]) and the smaller one is determined to be a non-noise pixel ([non (noise)] [115].

If both noise value A and noise value B are greater than threshold value T1, they are determined to be both noise pixels ([both (noise)] [133-YES]. Both noise value A and noise value B are less than threshold value T2, they are determined to be both non-noise pixels ([both non (noise)] [120].

Hereinafter, the noise determination is made for all the pixels (x, y) and pixels (X, Y) between which the aforementioned correspondence relationship holds and a noise mask is formed for each of the left-eye image and right-eye image and output [119]. Even if it has been determined that they are both non-noise pixels ([both non (noise)]), noise masks are formed because they are identified as being pixels determined by the corresponding pixel calculation module 13 to have no corresponding pixel (pixels failing to find any corresponding pixel).

Specifically, as shown in FIG. 4, noise value A for the right-eye pixel is calculated from the acquired right-eye image data [111] and noise value B for the left-eye pixel is calculated from the acquired left-eye image data [112].

Hereinafter, each of noise value A and noise value B is compared with threshold value T1 [113]. If A>T1 and B>T1 [113-YES], it is determined that A and B are both noise pixels ([both (noise)]) [114] and a noise mask is set [119].

Each of noise value A and noise value B is compared with threshold value T1 [113]. If A≦T1 and B≦T1 [113-NO], each of noise value A and noise value B is compared with threshold value T2 [115].

If the relationship between each of noise value A and noise value B and threshold value T2 satisfies the expressions A<T2 and B<T2 [115-YES], both A and B are non-noise.

If the relationship between each of noise value A and noise value B and threshold value T2 satisfies the expressions A≦T2 or B≧T2 (excluding A<T2 and B<T2), at least one is a noise image and the rest are non-noise images [115-NO].

Hereinafter, if the relationship between each of noise value A and noise value B and threshold value T2 satisfies the expressions A≦T2 or B≧T2 ([115-NO]), it is determined whether noise value A and noise value B satisfy the expression A<B [116]. If A<B [116-YES], it is determined that the left-eye pixel (pixel value B) is noise ([single (noise, left eye)][117]. Therefore, if A≦B [116-NO], the right-eye pixel (pixel value A) is noise ([single (noise), right eye]) [118].

Therefore, a noise mask is set for each of both noise pixels ([both (noise)]), noise ([single (noise, left eye)]), and noise ([single (noise), right eye])) [119].

Threshold value T2 is a value set by referring to the dispersion of pixel values or the like. The relationship between threshold value T2 and threshold value T1 satisfies the expression T1>T2 or T1<T2. Threshold value T2 is used to determine filter strength. The relationship may satisfy the equation T1=T2.

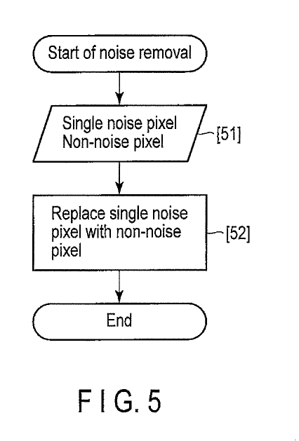

Next, FIG. 5 shows an example. The noise removal module 17 removes noise from single noise pixels ([single (noise)]) on the basis of the result of the noise determination (see FIG. 4) made by the noise determination module 15.

First, with the pixel correspondence information obtained from a left-eye image, a right-eye image, and FIG. 3, and the noise mask formed in FIG. 4 being input [51], the noise removal module 17 outputs a noise-removed left (right) image obtained by rewriting the value of a noise pixel of the left (right) eye image. In the noise removal process, pixel value U(x, y) of a single noise pixel (x, y) in the noise mask is replaced with pixel value V(X, Y) of the corresponding non-noise pixel (X, Y) [52].

The pixel values of all the single noise pixels ([single (noise)]) are replaced as described above, obtaining left-eye and right-eye images from which noise has been removed.

In the embodiment, the corresponding pixel calculation module may be based on any method, provided that the method is generally called a stereo matching method.

In addition, the noise value at the noise determination module represents a value indicating the amount of shift from a surrounding pixel. A plurality of absolute difference values with neighborhood pixels excluding the surrounding four pixels used in the explanation of FIGS. 3 and 4 may be added. Alternatively, difference square sum may be used instead of absolute difference.

If, the number of input images is three or more (multiple image), the correspondence relationship is found in the same manner. Of the three input images, a combination of arbitrary two images is input. All the combinations are processed in the same manner, enabling three or more images to be handled.

As described above, with the embodiment, the corresponding points of the same subject (two or more images taken from the same photographic subject at the same instant) are compared to obtain noise information originating in an imaging device, which enables noise (originating in the imaging device) to be distinguished.

In addition, noise can be removed with high accuracy by using corresponding values of the remaining one (the other) of the images as alternative pixels to noise.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing apparatus comprising:
a calculation module configured to find the correspondence between an arbitrary pixel of a first image input as a first image signal and an arbitrary pixel of a second image input as a second image signal acquired at the same time as the first image signal about the same subject;
a determination module configured to compare the arbitrary pixel of the first image with the arbitrary pixel of the second image based on the calculation result of the calculation module and to determine whether the individual pixels are noise pixels or non-noise pixels differing from noise pixels; and
a noise removal module configured to correct noise pixels based on the determination result of the determination module.

2. The image processing apparatus of claim 1, wherein the determination module is configured to form a noise mask used to correct pixels at the noise removal module based on the calculation result of the calculation module.

3. The image processing apparatus of claim 1, wherein the determination module is configured to form a noise mask used to correct pixels by using only pixels determined to be non-noise pixels based on the calculation result of the calculation module.

4. The image processing apparatus of claim 1, wherein the calculation module is configured to find the smallest value of the sum of absolute differences (SAD) setting the arbitrary pixel of the first image and the arbitrary pixel of the second image as alternative of a base pixel and a reference pixel, and, if the smallest value of SAD is less than a threshold value, to set the pixel that makes SAD the smallest as a pixel corresponding to the base pixel.

5. The image processing apparatus of claim 4, wherein the noise mask corresponds to the base pixel.

6. The image processing apparatus of claim 4, wherein the noise mask corresponds to the reference pixel corresponding to the base pixel.

7. The image processing apparatus of claim 4, wherein the noise mask corresponds to each of the base pixel and the reference and the pixel corresponding to the base pixel.

8. An image processing method comprising:
finding the correspondence between an arbitrary pixel of a first image input as a first image signal and an arbitrary pixel of a second image input as a second image signal acquired at the same time as the first image signal about the same subject; and
if there is a correspondence relationship between the arbitrary pixel of the first image and the arbitrary pixel of the second image, correcting a noise image based on the result of determining whether each couple of two pixels are noise pixels or non-noise pixels differing from noise pixels.

9. The image processing method of claim 8, further comprising:
forming a noise mask used for removing noise, if there is a correspondence relationship between the arbitrary pixel of the first image and the arbitrary pixel of the second image and it has been determined that the arbitrary pixel of at least either the first image or the second image has noise.

10. The image processing method of claim 9, further comprising:
using only pixels determined to be non-noise pixels to form a noise mask.

11. The image processing method of claim 8, further comprising:
finding the smallest value of the sum of absolute differences (SAD) and a reference pixel that makes SAD the smallest setting the arbitrary pixel of the first image or the arbitrary pixel of the second image as a base pixel and, if the smallest value of SAD is less than a threshold value, setting the pixel that makes SAD the smallest as a pixel corresponding to the base pixel.
